(19) United States
(12) Patent Application Publication
(10) Pub. No.: US 2025/0131233 A1
(43) Pub. Date: Apr. 24, 2025

(54) SYSTEMS AND METHODS FOR MANAGING POWER IN WEARABLE DEVICES

(71) Applicant: Welch Allyn, Inc., Skaneateles Falls, NY (US)

(72) Inventors: John A. Lane, Venice, FL (US); David E. Quinn, Auburn, NY (US); Tyson B. Whitaker, Arden, NC (US); Gene Wolfe, Pittsford, NY (US); WonKyung McSweeney, Manlius, NY (US)

(73) Assignee: Welch Allyn, Inc., Skaneateles Falls, NY (US)

(21) Appl. No.: 18/923,621

(22) Filed: Oct. 22, 2024

Related U.S. Application Data
(60) Provisional application No. 63/592,528, filed on Oct. 23, 2023.

(51) Int. Cl. G06K 19/077; G06V 40/16; H04N 23/695

(52) U.S. Cl. CPC G06K 19/07762; G06V 40/172; H04N 23/695

(57) ABSTRACT

Systems and methods for modifying power consumption of a wearable device are provided. The systems and methods include an imaging device, a directional antenna, and a power transmission device in combination with a wearable device. The imaging device, antenna, and power transmission device are positioned and re-positioned so that the wearable device is in the center of the field of view of at least one of the imaging device, antenna, and power transmission device. The systems allow for a decrease in the gain of the wearable device, decreasing power usage. The system may also allow for remote charging of the wearable device.

### CROSS-REFERENCE TO RELATED APPLICATION

This application claims priority to, and benefit of, U.S. Provisional Patent Application No. 63/592,528 filed Oct. 23, 2023, entitled SYSTEMS AND METHODS FOR MONITORING PATIENTS UTILIZING WEARABLE DEVICES, the entire contents of which are incorporated herein by reference.

### TECHNICAL FIELD

This application is directed to systems and methods for managing power in wearable devices.

### BACKGROUND

Traditional healthcare settings rely on healthcare professionals, such as nurses and doctors, to be physically in the presence of a patient in order to collect patient data. This data ranges from behavior patterns (e.g., bed exiting, falls, sleep, medication diversion, activities, and the like) to physical measurements (e.g., heart rate, respiratory rate, oxygen saturation, and the like). The in person, physical collection of information is extremely time consuming and can be burdensome for healthcare workers who are responsible for large numbers of patients. It may also be disruptive to patients as data may be collected around the clock. Further, as many of these measurements may not be immediately urgent, taking measurements may sometimes be overlooked, impacting patient care.

Some devices, such as wearable devices, allow for monitoring without clinician intervention. Such monitoring may be continuous or intermittent depending on the condition of the patient and the clinician's determinations. However, wearable devices have competing design issues and are not without their drawbacks. For example, for ease of use and patient comfort, it is desirable that wearable devices be lightweight and low-profile. However, monitoring patients and transmitting data requires relatively large amounts of power and commensurate energy sources. Current batteries are oftentimes heavy and bulky and may be uncomfortable for patients. Further, the recharging requirements of current wearable devices decrease their usefulness as human intervention is required to charge the wearables which may also disrupt monitoring.

The various example embodiments of the present disclosure are directed toward overcoming one or more of the deficiencies associated with wearable devices.

### SUMMARY

Current techniques for determining patient characteristics via patient data collected by wearable devices are not without limitations. For example, wearable devices, such as armbands and patches, may be used to obtain and transmit data associated with the respective wearer. For ease of use and patient comfort, it is desirable that such wearables be lightweight and low-profile. However, transmitting and receiving data requires power and more power requires bigger batteries. Thus, various implementations of the present disclosure are directed towards systems and methods for increasing the efficiency of power consumption by wearable (patient) devices whether in a care facility such as a clinic or a hospital setting, or at home as well as providing mechanisms for recharging wearable devices without necessitating human intervention.

The system may include an imaging device, an antenna, a power transmitter, and one or more sensors. The imaging device may include any device having imaging capabilities, such as a visible camera; an infrared camera; or a red, blue, green (RGB) camera, to name a few non-limiting examples. Such imaging devices may acquire images or videos episodically, periodically, or continuously. In some examples, the imaging device may include image-altering features such as pan, tilt, and zoom. The sensors may include any sensing devices capable of determining one or more measurements associated with a patient and may be attached to the patient or separate from the patient. In some aspects, the antenna may be a high-gain directional antenna. In some aspects, the power transmitter may transmit electromagnetic energy.

Some or all of the imaging device, the antenna, the sensor, and the power transmitter may be attached to a stand within a patient care area such as a hospital room. In some aspects, the stand is in a fixed location, in other aspects, the stand may be moveable. In some aspects, one or more of the imaging device, the antenna, the sensor, and the power transmitter may be attached to a moveable portion of the stand such as a gimbal. The stand, and/or the gimbal, may be configured to be steerable in at least one of an x-direction, a y-direction, or a z-direction within the care facility or other space.

Using the various methods and systems described herein, one or more of the imaging device, the antenna, the sensor, and the power transmitter may be positioned and re-positioned to achieve the goals of the device. For example, the gimbal may be positioned and re-positioned so that the imaging device may obtain a complete and accurate image of an environment. In some aspects, the gimbal may be positioned and re-positioned so that the transmissions between a wearable device and the antenna and/or power transmitter are optimized. In some aspects, the gimbal may be positioned and/or repositioned so that the sensor on the gimbal receives the desired information.

In some aspects, the gimbal may reposition based on receipt, by a computing device, of a first set of data. For example, the gimbal may reposition based on the identification of the location of the patient and/or the wearable within a first image or set of images. In some aspects, the gimbal may reposition based on identifying the position of a patient device from an identification signal sent by the patient device. In some aspects, the gimbal may mechanically tilt such that the antenna is pointed towards a sensor on a patient such as the wearable device, to increase the precision and gain, allowing for a narrower beam to be used. In other aspects, the gimbal may move along the z axis, changing the distribution of the power being transmitted by the power transmitter. For example, repositioning the gimbal may allow for a narrower beam of power to be transmitted to the wearable.

In some aspects, the techniques described herein relate to a method that includes receiving, via a computing device, real-time image data captured by an imaging device located in a room and using the image data to identify the presence and identity of a patient and/or wearable device within the room. Based on the location and identification of the patient and/or a wearable device, the position of the imaging device and other devices on the stand/gimbal, the position of the stand, and/or the position of the gimbal may be adjusted such that the patient and/or the wearable device is within the field of view of one or more of the imaging device, power transmitter, and/or antenna. In some aspects, the position of the devices such as the imaging device, power transmitter, and/or antenna, the position of the stand, and/or the position of the gimbal may be adjusted a single time. In other aspects, they may be adjusted a plurality of times. In some aspects, they may be adjusted continuously or nearly continuously based on the movement(s) of the patient. In some aspects, such adjustments may occur, at least in part, based on image data extracted from one or more images. In other aspects, such adjustments may occur, at least in part, based on transmissions to and from the wearable device.

In some aspects, upon identifying the location of a wearable and the distance of the wearable from the devices on the stand, the area inscribed by the region of progression of the energy from the power transmitter (cone angle) may be altered via movement of the gimbal and/or a collimator within the power transmitter. This may allow for a more focused beam of energy to be transmitted to a wearable device. Similar alterations may be made to the antenna, for example, in some aspects, the cone angle of the antenna may be adjusted to increase the precision and gain.

Patient data from the patient device such as a wearable may be captured at one or more time points. In some aspects, patient data from a first time point is compared to a second time point such that changes in a patient's condition or trends of a patient's condition may be captured. Patient data may be transmitted from the wearable device episodically, continuously, or periodically. In some aspects, the wearable device may have multiple modes of operation allowing for changes in transmission based on the presence or absence of the antenna, and/or power transmission from the power transmitter.

### BRIEF DESCRIPTION OF THE DRAWINGS

FIG. 1 illustrates a schematic block diagram of an example patient management system environment.

FIG. 2 illustrates a top-view of an example patient management system environment.

FIG. 3 illustrates a top-view of an example patient management system environment.

FIG. 4 illustrates an example process for obtaining data from a wearable device.

FIG. 5 illustrates an example process for charging a wearable device.

FIG. 6 illustrates an example process for obtaining data from a wearable device.

FIG. 7 illustrates an example process for charging a wearable device.

FIG. 8 illustrates an example process for charging a wearable device.

FIGS. 9A and 9B illustrate examples of a change in the cone angle due to repositioning the power transmitter and/or antenna.

FIG. 10 is an example computing system and device which may be used to implement the described techniques.

### DETAILED DESCRIPTION

Systems and methods disclosed and contemplated herein are directed towards managing power consumption and recharging in wearable (patient) devices. Various embodiments of the present disclosure will be described in detail with reference to the drawings, wherein like reference numerals represent like parts and assemblies throughout the several views. Additionally, any examples set forth in this specification are not intended to be limiting and merely set forth some of the many possible embodiments.

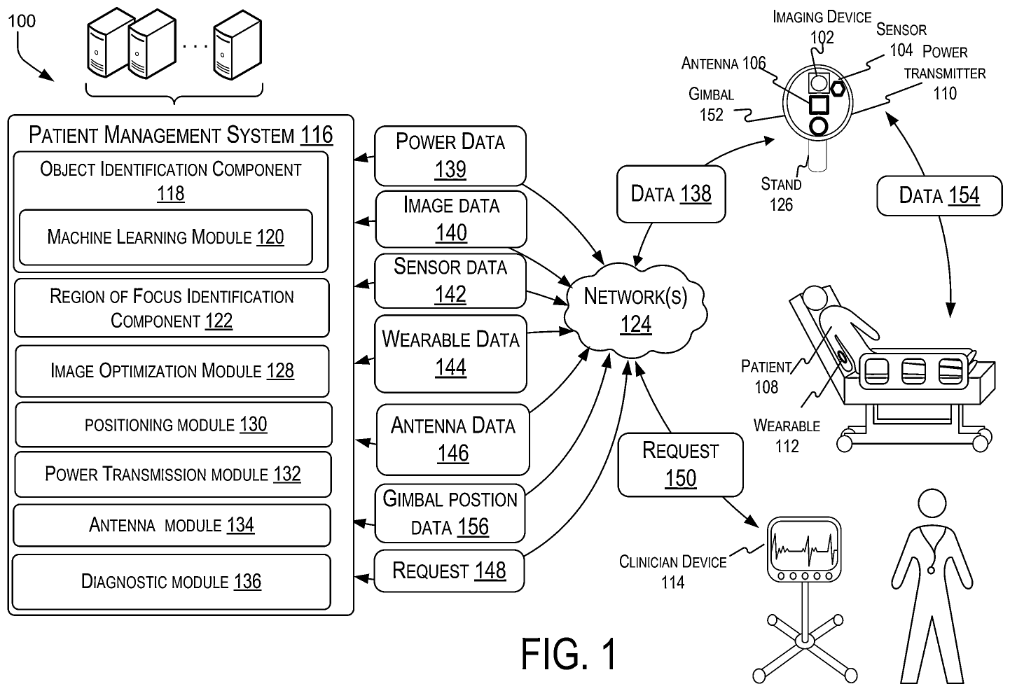

FIG. 1 shows a schematic block diagram of an example patient management system environment 100 used to monitor patients. The example patient management system environment 100 includes a portable stand 126 including a gimbal 152 and a plurality of devices; a handheld or freestanding clinician device 114; a patient management system 116; and a wearable device 112. As used herein, wearable, wearable device, and patient device may be used interchangeably. In some aspects, a wearable device may be referred to as a sensor, where the wearable sensor is at a location other than the stand 126 and/or gimbal 152.

The one or more stands 126 may have one or more imaging device(s) 102, sensor(s) 104, power transmitter(s) 110, and antenna(s) 106. In some aspects, one or more imaging device(s) 102, sensor(s) 104, power transmitter(s) 110, and antenna(s) 106 may be located independently. For example, an imaging device 102 may be attached to the wall or other surface within a patient room (not shown). In some aspects, an imaging device 102, sensor 104, antenna 106, and power transmitter 110, may be coupled to a gimbal 152 or other steerable structure on the stand 126, allowing additional movement of the one or more of the imaging device(s) 102, sensor(s) 104, power transmitter(s) 110, and antenna(s) 106, for gross and fine positioning and re-positioning. For example, the stand 126 may rotate such that the device(s) are facing the correct direction and/or are within a specific distance of a patient and/or wearable device. The gimbal 152 may be used to mechanically rotate around one or more axis (e.g., x, y, z), providing the imaging device 102, sensor 104, power transmitter 110, and antenna 106 with stability and maneuverability as the various devices obtain and transmit data and power. In some aspects, the movement of the gimbal may alter the cone angle, allowing for transmission from the power transmitter and/or the antenna to have more or less diffraction, changing the width of any transmission beam to a narrower, focused beam. In some aspects, the cone angle may alter the beam to match the size of the receiving device such as the wearable 112. Moreover, in some examples, one or more axes of the gimbal may be locked such that the imaging device 102, sensor 104, power transmitter 110, and antenna 106 is constrained to movement in a direction of an axis.

The imaging device 102 may include any device having imaging capabilities enabling the imaging device 102 to acquire images of objects in the environment, such as a healthcare setting. For example, the imaging device 102 may include a camera, such as an infrared camera, an RGB camera, a thermal camera, or other such imaging device to name a few non-limiting examples. In some examples, the imaging device 102 may include a device capable of capturing still images. Additionally or alternatively, the imaging device 102 may include a video camera that may be capable of capturing a stream of imaging data.

In some examples, the imaging device 102 may be utilized to determine a location of an object within the healthcare environment. For example, the patient management system 116 may identify a region of interest or focus using region of focus identification component 122 and instruct the imaging device to focus on a particular object or particular area of the patient management system environment 100. Such focus may include alterations to the light settings, aperture settings, zooming in or out, contrast, brightness, position, of the imaging device and the like. In some aspects, the images may be smoothed to reduce artifacts. In some aspects, the focus may include repositioning of the imaging device, for example by changing the position of the stand 126 or the gimbal 152. Oftentimes, the object being located may be a patient, such as patient 108; thus, the patient management system 116 may be configured to identify a patient 108 represented by data in an image, for example using object identification component 118, determine the location of the patient 108, for example using region of focus identification component 122, and re-position the imaging device 102 so that the center of the region of interest or field of view is the patient 108. However, in other examples, the object of interest may include objects around or on the patient such as one or more wearable devices such as wearable device 112, including wristbands, heart monitors, blood pressure cuffs, wireless electrode patches, ECG finger monitors, or other wearable devices.

In some examples, image data may be analyzed to detect the location of a plurality of objects in a healthcare environment. Such detection may occur simultaneously or serially from the same or different images or sets of images. In some examples, one or more images may be analyzed to identify one or more objects in the image(s). The location of an object of interest may then be used to provide instructions to the imaging device to focus on the region of interest including the object of interest. In some aspects, image acquisition and re-focusing may take place one or more times. In some aspects, the imaging device may focus and re-focus itself. In other aspects, the movement of the gimbal 152 using for example, positioning module 130 and gimbal position data 156, may be used to manipulate the imaging device. Information from images captured by the imaging device 102 can additionally be used to position other devices including the sensor 104, power transmitter 110, and antenna 106 by using information extracted from the images to re-position the stand 126, the gimbal 152, and/or one or more the devices independently.

In some examples, the example patient management system environment 100 may include one or more sensors, such as sensor 104 and wearable 112. In some aspects, the sensors may include a proximity sensor, a weight sensor, a physiological parameter sensor, and the like. For example, when sensor 104 includes a proximity sensor, the sensor may assist in locating the object of interest and the distance from the stand 126 and/or gimbal 152 to the object of interest. Such information may be used to change the width of transmission beams from one or more of the devices on the stand 126 and/or gimbal 152 such that the transmission is directed in a focused manner towards the item of interest such as the wearable 112.

In some aspects, the sensor may be a sensor measuring physiological parameters. For example, a sensor in the wearable 112 may measure a physiological parameter including one or more of motion, stress, vibration, temperature, acceleration, heart rate, neurological disease, cardiovascular disease, pulmonary disease, temperature, and the like may be part of the wearable 112. Physiological parameter sensors may include, for example, accelerometers, inertial sensors, electrocardiographs, biochemical sensors, and the like. Other sensors on a patient may include an insulin patch pump or continuous glucose monitoring patch.

The one or more sensors may be intended to be in contact with the patient, as in the case of the wearable 112, or removed from the patient, as in the case of the sensor 104 on the stand 126. In some aspects, the wearable 112 may be detached from the patient, for example, if the patient is not being monitored for some reason. While in FIG. 1, the wearable device 112 is shown as positioned on or near the wrist of the patient 108, the wearable device 112 may be located elsewhere on the body of the patient, for example, on the chest of the patient. Further, the wearable device 112 may be exposed to the surrounding environment as shown in FIG. 1, or occluded such as by a blanket or gown (not shown).

Data collected by the sensors may be transmitted to the patient management system 116. In some aspects, data is sent to a remote device such as clinician device 114. In examples, the clinician device 114 may include a computing device such as a mobile phone, a tablet computer, a laptop computer, a desktop computer, and so forth which may provide a clinician (e.g., a doctor, nurse, technician, pharmacist, dentist, etc.) with information about the health of the patient 108. In some cases, the clinician device 114 may exist within a healthcare establishment, although examples are also considered in which the clinician device 114 exists and/or is transported outside of a healthcare establishment, such as a doctor's mobile phone or home desktop computer that the doctor may use when the doctor is on-call. In some examples, the clinician device 114 may include a processor, microprocessor, and/or other computing device components, shown and described below.

In some aspects, data from the wearable device 112 is collected via antenna 106 as seen by data 154. In some examples, the antenna 106 may be a directional antenna. In some aspects, the antenna 106 may be a high efficiency, directional, high gain antenna optimized for transmissions in the field of view of the imaging device 102 such as the transmission of patient data by the wearable 112.

A high-gain directional antenna is an antenna with a focused, narrow beam width, which permits more precise targeting of signals from a greater distance. While wearable devices send signals omnidirectionally, the use of a directional antenna focused on the wearable allows for the gain of the wearable to be decreased, decreasing the power consumption of the wearable. That is, the high gain of the antenna 106 allows for the capture of a low gain signal of the wearable 112. In some aspects, the gain of the directional antenna may be adjusted based on the signal from the wearable. In some aspects, the use of a directional high-gain antenna may improve the signal-to-noise ratio of the signal transmitted by the wearable device. For example, the signal-to-noise ratio using an omnidirectional antenna is 1:1. In contrast, with a directional antenna as described herein, the signal-to-noise ratio may be 100:1, 75:1, 50:1, 25:1, 10:1, 5:1, 3:1, 2:1 or any fraction thereof. In the case of a 100:1 signal-to-noise ratio, a transmission emitted from the wearable may use 1/100^{th} power that would be needed by a conventional wearable transmitting to a non-directional antenna. Similar ratios of power usage decrease would occur at different signal-to-noise ratios. For example, a signal-to-noise ratio of 75:1 would allow a transmission emitted from the wearable to use 1/75^{th} of the power that would be needed if antenna 106 was an omnidirectional antenna. A signal of 10:1 would allow a transmission emitted from the wearable to use 1/10^{th} of the power that would be needed if antenna 106 was an omnidirectional antenna. In some aspects, the power usage of the wearable may be between 0.5 milliwatts and 30 milliwatts such as between 1 milliwatt and 30 milliwatts. For example, the power usage of the wearable may be 25 milliwatts, 20 milliwatts, 10 milliwatts, 5 milliwatts, 2.5 milliwatts, or 1 milliwatt. In some aspects, the power usage may be less than 30 milliwatts. Such power usage may be used by the wearable for transmission and/or data collection. In some aspects, the position and cone angle of the antenna 106 may be adjusted to increase precision and gain, allowing for reduction of the power requirements of the wearable. Such an adjustment may be generated, for example by moving one or more of the stand 126, the gimbal 152, and/or the antenna itself. In some aspects, the antenna 106 is positioned based on information obtained from one or more images captured by the imaging device 102. In other aspects, the adjustment may be made due to a signal received from the wearable 112.

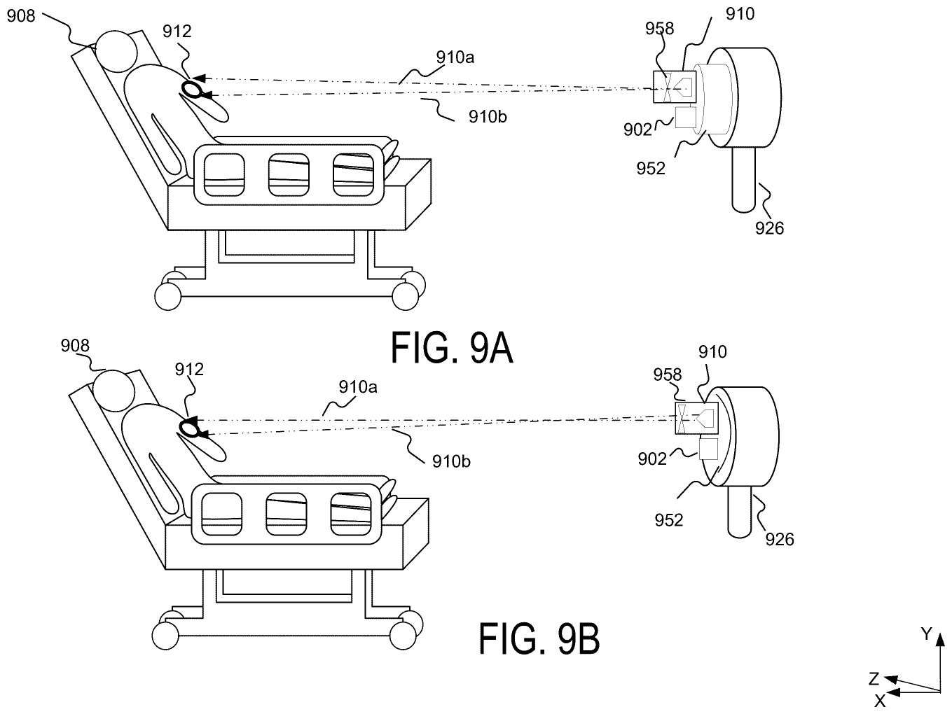

The cone angle is the boundary between an area where a signal is present and an area where it is not. It is the angle formed at the source point by the edges of the radiated energy pattern. From the source point, the energy radiates outwards, and the cone angle defines the spread of this energy in a conical shape. It is measured between the axis of symmetry (the center of the cone) and the outer boundary of the energy transmission in any given direction. The angle determines how the boundary behaves over distance from the source or target specifically with regard to a point source or point target. The further the distance, the more area is inscribed inside the cone. The smaller the angle, the less area is inscribed. In some aspects, antenna module 134 may adjust the cone angle of the antenna 106 to less than 10°. In other aspects, the cone angle of the antenna may be 0.5°. In some aspects, the cone angle of the antenna is updated based on information acquired from the imaging device 102. For example, the position and/or angle of the antenna 106 may be adjusted based on the distance between the antenna 106 and the wearable 112 as shown in further detail in FIG. 9A. In some aspects, the position of the antenna may be adjusted based on the location in arc seconds of the transmittal from the wearable 112 so that the number of seconds or degrees of travel is congruent with the distance of the wearable 112 to the transmitter 110, such that the curve of the transmission from the antenna will be the size of the wearable 112.

In some examples, the patient management system environment 100 may allow for remote charging of the wearable device 112, decreasing or eliminating the need for a battery in the wearable 112. For example, the patient management system environment 100 may include a power transmitter 110 on the stand 126 or gimbal 152. The power transmitter 110 may be instructed by the power transmission module 132 to send energy over the air. In some aspects, the power transmitter 110 may transmit any electromagnetic energy that is useful for communication. For example, the electromagnetic energy may be beam formed RF (AC) energy. In other aspects, power transmitter 110 could transmit an optical power laser at a terahertz to charge a solar panel on the wearable. In some aspects, the power transmitter 110 may be an RF inductive coil. In some aspects, the RF inductive coil uses directional transmitting in the mega or gigahertz range. In some aspects, the wearable may have an optical receiver. The use of the power transmitter 110 may allow for the transfer of milliamps from the power transmitter 110 to the wearable 112.

In some aspects, there may be an angle of operational intensity at which there is a maximum transmission rate. Thus, positioning the wearable such that the wearable 112 is within the center of the field of view of the power transmitter 110 may allow for the maximum power transmission rate. In some aspects, the cone angle of the power transmitter 110 may be adjusted to focus the power on the wearable 112 while avoiding at least a portion of the area surrounding the wearable. For example, the area inscribed by the region of progression of the energy from the power transmitter (cone angle) may be altered via movement or the gimbal 152 and/or a collimator within the power transmitter, allowing for a more focused beam of energy to be transmitted to the wearable device 112. In some aspects, the cone angle may be such that the number of arc seconds or degrees of travel is congruent with the distance of the patient 108 from the transmitter 110 so that there is no overlap beyond the energy transmission and the receiving area, ie. the wearable 112. In some aspects, the cone angle may be, for example, less than 10°. In other aspects, the cone angle of the power transmitter may be 0.5°. In some aspects, the cone angle of the power transmitter 110 is updated based on information acquired from the imaging device 102. For example, the position and/or angle of the power transmitter 110 may be adjusted based on the distance between the power transmitter 110 and the wearable 112. The use of tuned power delivery may allow for a decrease in the amount of power that needs to be transmitted and an increase in the amount of power the wearable 112 is able to absorb. For example, omnidirectional power transmission can charge devices in any direction or position. However, as it is unlikely that there is a device in all directions, this wastes a lot of energy. In contrast, with focused transmission, the amount of energy that needs to be transmitted may be a fraction of the amount transmitted by an omnidirectional power transmission.

In some aspects, the wearable 112 may have a tuned circuit, for example, using a photoelectric effect or Seebeck element to capture the energy from the power transmitter 110, increasing the efficiency of the charging. The power transmission may be continuous or intermittent. In some aspects, the use of a power transmitter 110 may allow for the replacement of the primary battery of wearable 112 with a small power reservoir and an RF energy harvesting coil/rectifier sub-system.

In some aspects, the wearable 112 may include a capacitor such that the wearable continues to be powered while the gimbal or power delivery system is being positioned or the power delivery system is otherwise temporarily unavailable to charge the wearable 112. In some aspects, the wearable may include a supercapacitor or a primary battery such as a coin cell battery. In some aspects, the wearable 112 may be charged prior to being attached to the patient.

The wearable may have one or more modes of power consumption depending on the task being undertaken and/or the amount of power available. In some aspects, loss of power transmission to the wearable may initiate a power-saving mode by the wearable 112. For example, during a power outage, the wearable 112 may buffer the data into an internal memory, that is if the wearable 112 is not receiving power from a power delivery system, it does not transmit data until power is being received, thereby conserving energy and minimizing monitoring disruption. In some aspects, when the patient is discharged, the wearable device 112 may be moved to a location within the environment which the region of focus identification component 122 identifies as a standby or end position, and the power transmission module 132 may instruct the power transmitter 110 to stop sending power and the wearable device 112 may enter a hibernation mode.

The power transmitter 110 transmits electromagnetic waves that vary according to the distance, frequency, and conducting environment. The attenuation of radio energy between the power transmitter and the wearable is characterized by near-field and far-field. Near-field is the space that lies within the Fraunhofer's distance, and the far-field region lies outside the Fraunhofer's distance. Conversion efficiency can be calculated as a ratio of the power delivered (transmitted) to the power retrieved (received) and used to improve the settings of the power transmitter 110 based on the proximity of the power transmitter 110 to the wearable device 112. For example, the receiver (wearable 112) may have a fixed sensitivity and thus the power transmitter 110 must maintain a power level to meet this minimum at a specific distance between the power transmitter 110 and the wearable device 112. By altering the position of the power transmitter 110 or a collimator within the power transmitter, the width of the transmission beam may be altered as shown in more detail in FIGS. 9A and 9B. The use of tuned or focused transmission may increase the conversion efficiency.

The example patient management system environment 100 may also include a patient management system 116 which may be comprised of one or more server computing devices, and which may communicate with the imaging device 102, sensor 104, antenna 106, power transmitter 110, and wearable 112 to respond to queries, receive data, respond to data, provide instructions, and so forth. Communication between the patient management system 116, the imaging device 102, the sensor 104, the power transmitter 110, the antenna 106, the stand 126, the gimbal 152, and/or the clinician device 114 occurs via one or more networks 124 where the communication can include imaging data, sensor data, wearable data, patient data related to the health of the patient 108, position information of the wearable 112, and/or positioning information for the one or more devices. As shown in FIG. 1, data 138 captured by or received from one or more of the imaging device 102, sensor 104, power transmitter 110, antenna 106, and wearable device 112 is transmitted using a network 124 to and from the patient management system 116.

The network 124 is typically any type of wireless network or other communication network known in the art. Examples of the network 124 include the Internet, an intranet, a wide area network (WAN), a local area network (LAN), a virtual private network (VPN), cellular network connections, and connections made using protocols such as 802.11a, b, g, n and/or ac. Alternatively or additionally, the network 124 may include a nanoscale network, a near-field communication network, a body-area network (BAN), a personal-area network (PAN), a near-me area network (NAN), a campus-area network (CAN), and/or an inter-area network (IAN).

The imaging device 102, sensor 104, antenna 106, and power transmitter 110, may receive and transmit data such as data 154 from and to the wearable. The imaging device 102, sensor 104, antenna 106, power transmitter 110, gimbal 152, stand 126, and wearable 112 may send and receive information via transmission of data 138 through the network 124. Power data 139, image data 140, sensor data 142, wearable data 144, and antenna data 146 may be transmitted to and received from one or more servers of the patient management system 116 from the corresponding device on the stand 126. Such data may include patient information, device information, and patient/and or device position information. Such information may additionally include position data for the gimbal 152 and/or the stand 126. While shown collectively as data 138 and data 154, data 138 and data 154 may independently include one or more types of data sent from and/or received by one or more of the imaging device 102, the sensor 104, the antenna 106, the power transmitter 110, the wearable 112, the stand 126, and the gimbal 152. For example, the wearable device 112 may transmit data 154 regarding a patient condition such as heart rate, respiration rate, oxygen levels, temperature, blood pressure, and the like. The data may be received by the antenna 106 and transmitted via data 138 and network 124 to patient management system 116. Wearable device 112 may receive information from the patient management system 116 as to what type of information to collect and when to collect and/or transmit the data. Power transmitter 110 may receive information as data 138 from the patient management system 116. The information received by the power transmitter 110 may include information such as the position of the wearable 112, including the distance from the power transmitter 110 to the wearable 112 and the orientation of the wearable relative to the power transmitter 110, the current amount of charge of the wearable 112, the cone angle to be used for the transmission of the power, the amount and/or type of power to be transmitted by the power transmitter 110 and the like. Such information may be based in part on information received by the patient management system 116 from one or more other devices such as information extracted from images collected by the imaging device 102, information from the antenna 106, and/or information from the wearable 112.

Similarly, the antenna 106 may receive information as data 138 from the patient management system 116. The information received by the antenna 106 may include information such as the position of the wearable 112, including the distance from the antenna to the wearable 112, and the relative orientations of the antenna 106 and the wearable 112. Additional information can include the gain of the antenna and the cone angle to be used. The information received by the antenna 106 may be used to re-position the antenna 106, the stand 126 and/or the gimbal 152 so that the antenna 106 position is optimized relative to the wearable 112. In some aspects, the power transmitter may use information provided by the wearable to adjust the focus, beam angle, and power to be used.

In some aspects, the sensor 104 may collect information via data 154 regarding the room, the patient 108, and/or objects in the room including the wearable 112. In some aspects, sensor 104 may transmit information via data 138 about the patient, the room, and/or the condition of objects in the room. In some aspects, the sensor 104 may receive data via data 138 from the patient management system 116 regarding what type of information to collect, or positioning data based on the location of an object of interest as identified by the region of focus identification component 122. In some aspects, the imaging device 102 may acquire images, transmit images, analyze images, and receive or transmit positioning data based on the images to and from the patient management system 116. The position of the imaging device 102 may be altered based on information extracted from the images by, for example, the object identification component 118 including the machine learning module 120 as well as information obtained from one or more other devices including the wearable 112, the power transmitter 110, the sensor 104 and/or the antenna 106.

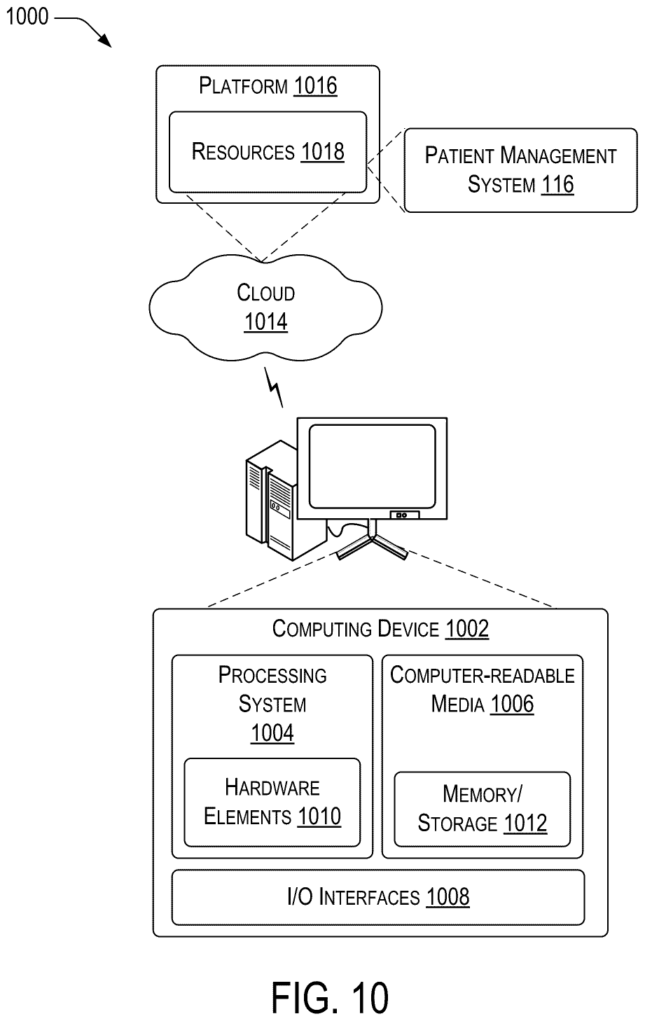

Data 138 may include transmitted and received data from each of the stand 126, the gimbal 152, the imaging device 102, antenna 106, sensor 104, and power transmitter 110 independently. Requests for information such as request 148 and request 150 may be sent to and from the collective devices including the clinician device 114 via networks 124 to the patient management system 116 or one or more other devices. A server of the patient management system 116 may act on requests such as requests 148 or 150 from the imaging device 102, the sensor 104, the power transmitter 110, the antenna 106, the wearable 112, and/or the clinician device 114, determine one or more responses to these queries, and respond back to the imaging device 102, the sensor 104, the antenna 106, power transmitter 110, wearable 112 and/or the clinician device 114 via the network 124, with instructions conveyed in data 138. In some aspects the patient management system 116 may send a request 148 to one or more of the devices requesting additional information including information about the patient 108, the wearable 112, the stand 126, the gimbal 152, the imaging device 102, the antenna 106, the sensor 104 and/or the power transmitter 110. A server of the patient management system 116 may also include one or more processors, microprocessors, or other computing devices as discussed in more detail in relation to FIG. 10.

The patient management system 116 may include one or more database systems accessible by a server storing different types of information. For instance, a database can store correlations and algorithms used to manage the imaging data, signal data, patient data, and other data to be shared between the imaging device 102, the sensor 104, the antenna 106, the power transmitter 110, the wearable 112, the gimbal 152, the stand 126, and/or the clinician device 114. A database can also include clinical data. A database may reside on a server of the patient management system 116 or on separate computing device(s) accessible by the patient management system 116.

In some examples, the imaging device 102, the sensor 104, the antenna 106, the power transmitter 110, gimbal 152, stand 126, and the wearable 112 may generate, store, and/or selectively share signals, imaging data, sensor data, positioning data, charging data and/or other mechanical and patient data between one another to provide the patient and/or clinicians treating the patient with improved outcomes by accurately monitoring the patient characteristics. In some instances, the data may be analyzed through a diagnostic module such as diagnostic module 136 and an alert may be sent to a clinician when a change in the characteristics of the patient may indicate that the patient needs caretaker intervention.

For example, the imaging device 102 may capture image data associated with a patient in a healthcare facility and send the image data to the patient management system 116. In some examples, capturing the image data may be in response to a request 150, such as by a clinician inputting information into a clinician device 114, to determine and/or monitor a characteristic associated with the patient. The characteristic may include any number of measurable metrics associated with a patient, such as vital signs (e.g., a body temperature of the patient, a pulse rate of the patient, a respiratory rate of the patient, a blood pressure of the patient, etc.), intake and output (e.g., fluid intake and fluid outtake, medicine intake, etc.), or a movement of the patient, to name a few non-limiting examples. The characteristics may be monitored directly through the wearable 112, or indirectly via the sensor 104.

In some examples, the patient management system 116 may process the image data to optimize the image. For example, the patient management system 116 may input the image data into an image optimization module 128 of the patient management system 116 which may alter the image data such that the image data is optimized to be at a highest quality. For example, the image optimization module 128 may automatically assess the image data and adjust the image data to increase a resolution of the image data, re-format the image data into a correct format, re-size the image data to a correct dimension, sharpen the image, segment the image, or compress the image data, to name a few non-limiting examples. In some aspects, the images may be optimized using image smoothing and enhancing techniques, removing movement that may be attributable to the motion of the gimbal 152, stand 126 and/or one or more of the devices on the gimbal 152 or stand 126. Image smoothing may be executed using a median filter, a Gaussian filter, a mean-value filter, a normalized filter, a bilateral filter, or the like, or any combination thereof. Thus, by optimizing the image data, the patient management system 116 may obtain more accurate images, thereby more accurately identifying the object(s) in the image data and positioning the devices on the stand based on the image information.

In some examples, the patient management system 116 may determine the identity of the object. For example, based on capturing the image data, the imaging device may send the image data to an object identification component 118 of the patient management system 116. In some examples, the object identification component 118 may include a machine learning module 120 trained to identify one or more objects in the image data. For example, the machine learning module 120 may include an artificial neural network, a convolutional neural net, generative artificial intelligence, a decision tree, a regression algorithm, or other machine learning algorithm to determine one or more objects in image data. For example, the system patient management system 116 may use Yolo object identification. The machine learning module 120 may be trained using training data including other image data including one or more objects. Using the training data, the machine learning module 120 may be trained to detect and/or identify objects within the image data. Moreover, the machine learning module 120 may use image data previously imputed into the machine learning model to continue to train the machine learning model, thus increasing the accuracy of the machine learning model.

Machine learning may be performed using a wide variety of methods or combinations of methods, such as contrastive learning, supervised learning, unsupervised learning, temporal difference learning, reinforcement learning, and so forth. Some non-limiting examples of supervised learning which may be used with the present technology include AODE (averaged one-dependence estimators), artificial neural network, back propagation, Bayesian statistics, naïve bayes classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, subsymbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Another example of machine learning includes data pre-processing. Specific details regarding any of the examples of supervised, unsupervised, temporal difference or other machine learning described in this paragraph that are generally known are also considered to be within the scope of this disclosure. Support vector machines (SVMs) and regression are a couple of specific examples of machine learning that may be used in the present technology.

In some examples, the machine learning module 120 may include access to or versions of multiple different machine learning models that may be implemented and/or trained according to the techniques described herein. For example, the machine learning model may be trained using annotated video data of patient care facilities, object detection models, pose estimation standard models, and/or synthetic data using 3D models. Any suitable machine learning algorithm may be implemented by the machine learning module 120. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. For example, the machine learning models may include models for object recognition, sensor data processing, person identification, and the like for targeting data and energy transmission and collection between a wearable and the one or more devices on the stand 126.

Based on determining the object within the image data, a region of focus identification component 122 of the patient management system 116 may identify a region of focus formed by the object. The region of focus may include a “target” region in which a sensor may more accurately acquire sensor data associated with the object. For example, based on receiving the request, the patient management system 116 may determine a region of interest associated with the object that is likely to be associated with the request. In one aspect, a region of focus for a sensor determining a respiratory rate of a patient may be a chest of the patient. In other aspects, the region of focus may include the wearable 112. In some examples, the region of focus identification component 122 may determine the region of focus based in part on the request to determine and/or monitor a health-related measurement associated with the patient.

Based on identifying the region of focus, the patient management system 116 may cause the steerable stand 126 or objects on the steerable stand 126 to move via positioning module 130 so that the wearable device or other area of interest is in the center of the field of view of one of the devices such as the imaging device 102. The patient management system 116 may then activate the high gain directional antenna 106 via antenna module 134. A high-power transmission may then be sent to the wearable, instructing the wearable to enter low power transmission mode. The wearable 112 may then enter low power monitoring mode and send readings back to the antenna 106 and from the antenna 106 to the patient management system 116. In some aspects, the patient management system 116 may additionally include a power transmission module 132 that instructs the power transmitter 110 to transmit power to the wearable 112. Once the wearable receives enough power to begin operation, it may send a signal to the antenna 106 to assist in identifying the location of the wearable 112 so that the antenna 106 may be re-positioned to decrease the signal-to-noise ratio.

For example, in some aspects, the imaging device 102 may acquire an image of the patient 108. In some aspects, the imaging device 102 may pan across the room until it locates the object of interest such as the patient 108 or the wearable 112. In other aspects, the wearable 112 may emit a signal that allows the imaging device 102 to locate a region in which the wearable 112 is located even if the wearable 112 is not readily visible. Based on the location of the patient 108 and/or the wearable 112, the positioning module 130 may reposition one or more of the stand 126, the gimbal 152, or the devices on the stand 126 so that the wearable or other region of interest is in the center of the field of view of the imaging device 102 and in line with the antenna 106 and/or power transmitter 110. In some aspects, the positioning of the stand 126 or the devices on the stand may be a multi-step process in which a first object is identified and the stand 126 or devices are positioned to focus on the first object and then a second object associated with the first object is identified and the stand 126 or devices are re-positioned to focus on the second object. For example, the first object may be a patient and the second object may be a wearable attached to the patient.

In some aspects, the imaging device 102 may acquire a plurality of images and as the position of the patient changes, the positioning of the gimbal or antenna may be intermittently or continuously adjusted such that the wearable 112 continues to be positioned to receive power from the power transmitter 110 and/or to have the antenna 106 positioned to receive the data transmitted by the wearable.

In some aspects, the wearable device 112 may have multiple modes of operation, for example, a low-power operational data mode (seek the wearable for initial chirp), a high-power identification mode (charging wearable with continuous data transmission), a continuous transmission mode, a hibernation or sleep mode (where power or data is not transmitted), and the like. Thus, a wearable device 112 may initially send a signal to either the power transmitter 110 and/or the antenna 106 initiating the action of the antenna 106 and/or the power transmitter 110. For example, the antenna may be activated either by a signal from the wearable or a signal sent by the patient management system 116. The antenna 106 may then send a signal to the wearable to enter low power transmission mode. The wearable 112 may then enter low power transmission mode and send patient readings to the antenna 106. The readings may then be transmitted from the antenna 106 through the network 124 to the patient management system 116.

In some aspects, the power transmitter 110 may be activated by the patient management system 116 such as through power transmission module 132. In other aspects, the power transmitter 110 may be activated by a signal from the wearable. For example, the power transmitter 110 may be activated by a signal to start transmitting power to a wearable, thereby charging the wearable. In some aspects, the wearable 112 may change its status based on receiving power from the power transmitter 110, that is it may have an identification mode and a charging mode. For example, the wearable 112 may be in standby mode until it receives power from the power transmitter 110. In other aspects, the wearable 112 may emit a signal to initiate power transmission from the power transmitter 110.

In some aspects, the wearable 112 may transmit data at a plurality of time points. For example, sensors such as sensor 104 or wearable 112 may capture first sensor data at a first time, wherein the first sensor data indicates a first inhalation. The sensor 104 or wearable 112 may then capture second sensor data at a second time, wherein the second sensor data may indicate a second inhalation of a patient. Based on determining a change in movement from the first time to the second time, the patient management system 116 may determine the respiratory rate of the patient. Other measurements of patient actions or conditions by the wearable device 112 may also be obtained.

In some examples, wearable 112 may collect data at multiple times to determine that the patient requires or is likely to require caretaker intervention. For example, based on receiving first sensor data and second sensor data such as wearable data, a diagnostic module 136 of the patient management system 116 may determine a difference between the first sensor data and the second sensor data. In some examples, a difference between the first sensor data and the second sensor data may indicate a normal fluctuation associated with a condition. For example, a slight variation in the heart rate of a patient may be normal and may not be a cause for concern. However, a larger variation may indicate a change in a condition of the patient, which may require intervention by a clinician. For example, the diagnostic module 136 may determine that the difference between the first sensor data and the second sensor data is greater than or equal to a threshold difference. The threshold difference may be specific to the condition and/or the patient, such that a determination that the difference between the first sensor data and the second sensor data is greater than or equal to the threshold difference may accurately indicate that the patient is likely to require assistance or intervention. For example, if a difference between blood pressure acquired with the first sensor data and blood pressure acquired with the second sensor data varies by more than a threshold amount, it may indicate that the patient is suffering from blood loss that needs to be addressed.

In some examples, based on a determination that the threshold difference between the first wearable data and the second wearable data is greater than or equal to the threshold difference, the diagnostic module 136 may generate a notification indicative of the difference. Diagnostic module 136 may then send a notification, including the difference between the measurements, to the clinician device 114, thereby alerting the clinician that the patient may require intervention or assistance. For example, the alert may appear automatically on the clinician device as a pop-up notification, indicating to the clinician that the patient may be in need of assistance or intervention.

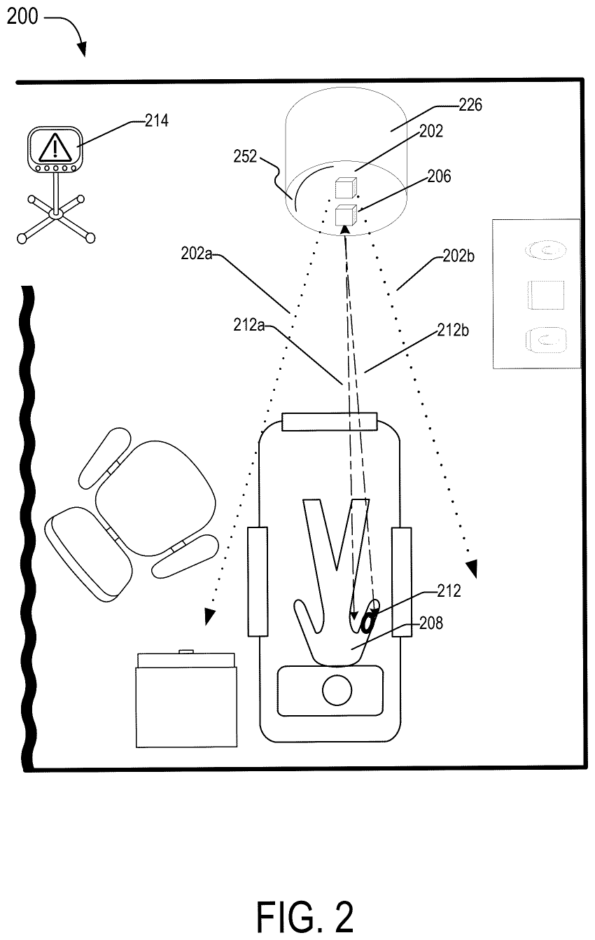

Example configurations of the one or more of the imaging device 102, sensor 104, power transmitter 110, and antenna 106 and methods for their use, are shown and described with reference to at least FIGS. 2-9B below.

FIG. 2 illustrates a top-view of an environment 200 for a patient management system. While the environment 200 is illustrated as a hospital room housing a patient 208, this application anticipates the environment 200 being any healthcare setting in which a patient may be observed, such as an operating room, an outpatient facility, a clinical lab, to name a few non-limiting examples. In some aspects, it may be a home environment. The environment 200 may include an imaging device 202 similar to imaging device 102, an antenna 206 similar to antenna 206, a gimbal 252 similar to gimbal 152, a stand 226 similar to stand 126, and a wearable 212 similar to wearable 112 described above with respect to FIG. 1. The environment 200 may additionally include a clinician device 214, which may be the same as or similar to the clinician device 114.

In some examples, the imaging device 202 may obtain image data of the environment 200. For example, illustrated by the dotted lines 202a and 202b, the imaging device 202 may scan or otherwise take images of the environment 200. The imaging data may then be analyzed to identify one or more objects in the environment, for example using machine learning via machine learning module 120 or object identification via object identification component 118. An object may be anyone or anything in the patient area. In some aspects, the object may be the patient 208. In other aspects, it may be a caregiver. In some aspects, the analysis may detect a plurality of objects such as a patient and a wearable 212. In the current illustration, the object of interest is a wearable 212.

Based on the determination of the location of the wearable, one or more of the antenna 206 and/or gimbal 252 may be repositioned so that the wearable is in the center of the field of view of the imaging device 202 and in line with the antenna 206 (center of the field of view of the antenna). As shown in FIG. 2, the wearable is off-center from the imaging field of view illustrated by dotted lines 202a and 202b. Thus, the positioning module 130 may change the position of the stand 226, imaging device 202, the gimbal 252, and/or antenna 206 so that the wearable 212 is in the center of the field of view of the imaging device 202 and the antenna 206 is pointed at the wearable (wearable is within the center of the field of view of the antenna). In some aspects, the antenna 206 may be a high efficiency, directional, high gain antenna optimized for receiving, in the field of view of the imaging device 202, data from devices such as the wearable 212. The high gain of the antenna 206 may allow for the capture of the low gain signal of the wearable 212. In some aspects, the gain of the directional antenna may be adjusted based on the signal from the wearable such that the low gain transmission from the wearable, as illustrated by the dashed lines 212a and 212b, is capable of being acquired by the antenna 206. In some aspects the transmission illustrated by the dashed lines 212a and 212b may be bidirectional, that is the antenna 206 and wearable 212 both transmit and receive information from each other. For example, the antenna 206 may send a signal to the wearable 212 instructing the wearable to enter low power transmission mode. In low power transmission mode, the wearable may transmit information such as the measurements taken by the wearable and/or the amount of charge contained by the wearable. In other examples, the wearable 212 may send an identification signal to the antenna 206, allowing the antenna 206 to be appropriately positioned. In some aspects a signal from the wearable and information from one or more images acquired by the imaging device 202 may be used to position the antenna. For example, the information may be used to position the antenna such that the area inscribed by the region of progression of the transmission (cone angle) emitted by the antenna, as shown by 212a and 212b, may be altered via movement of the antenna, the gimbal and/or a collimator associated with the antenna to increase the precision and gain of the antenna.

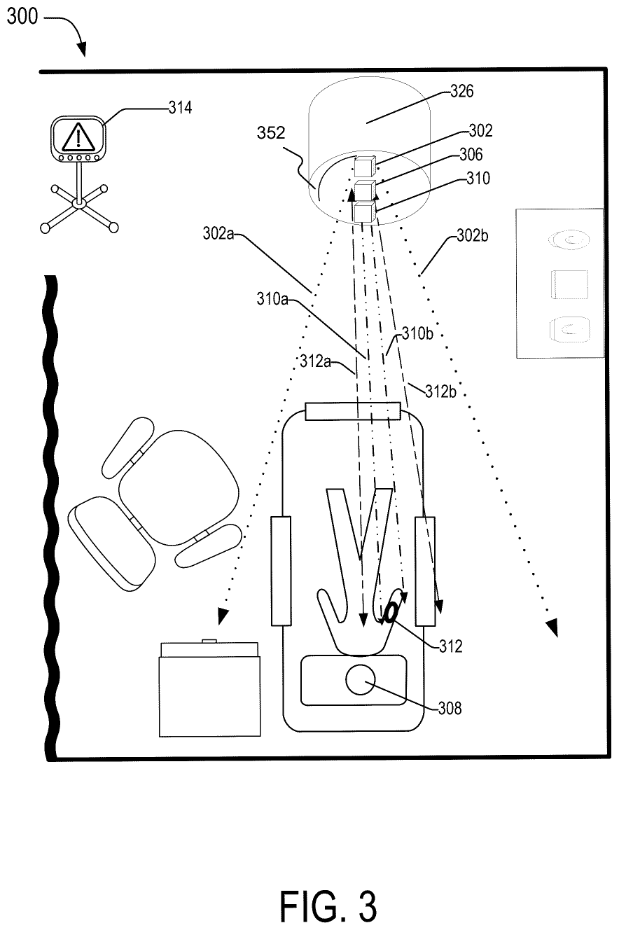

FIG. 3 illustrates a top-view of an environment 300 for a patient management system. While the patient management system environment 300 is illustrated as a hospital room housing a patient 308, this application anticipates the environment 300 being any healthcare setting in which a patient may be observed, such as an operating room, an outpatient facility, a clinical lab, to name a few non-limiting examples. In some aspects, environment 300 may be a home environment. The patient management system environment 300 may include an imaging device 302 similar to imaging device 102, a sensor similar to sensor 104 (not shown), antenna 306 similar to antenna 106, power transmitter 310 similar to power transmitter 110, a stand 326 similar to stand 126, a gimbal 352 similar to gimbal 152, and wearable 312 similar to wearable 112 as described above with respect to FIG. 1. The environment 300 may additionally include a clinician device 314, which may be the same as or similar to the clinician device 114.

Based on the determination of the location of the wearable, one or more of the antenna 306, power transmitter 310, stand 326, and/or gimbal 352 may be repositioned so that the wearable is in the center of the field of view of the imaging device 302 and in line with the antenna 306, and the power transmitter 310. As shown in FIG. 3, the wearable is off-center from the imaging field of view as illustrated by dotted lines 302a and 302b. Thus, the positioning module 130 may change the position of the stand 326, imaging device 302, gimbal 352, antenna 306, and/or power transmitter 310 so that the wearable 312 is in the center of the field of view of the imaging device 302 and the antenna 306 and power transmitter 310 are pointed at the wearable.

Similarly to FIG. 2, the high gain antenna 306 allows for capture of the low gain signal of the wearable 312. In some aspects the transmission illustrated by the dashed lines 312a and 312b may be bidirectional, that is the antenna 306 and wearable 312 both transmit and receive information from each other as described in further detail with reference to dashed lines 212a and 212b.

The power transmitter 310 may send a beam formed RF (AC) energy over the air as shown by dashed and double dotted lines 310a and 310b. The area inscribed by the region of progression of the energy from the power transmitter (cone angle) shown by dashed and double dotted lines 310a and 310b may be altered via movement of the power transmitter 310 itself, the gimbal 352, or the stand 326. In some aspects, the power transmitter 310 may include a collimator. The manipulation of the cone angle may allow for a more focused beam of energy to be transmitted to the wearable device 312. Thus, milliamps may be transferred from the power transmitter 310 to the wearable 312. The wearable may have a tuned circuit to capture the energy from the power transmitter 310, decreasing or eliminating the need for a battery. The power transmission may be continuous or intermittent. In some aspects, the wearable may include a capacitor such that the wearable continues to be powered while the gimbal or power delivery system is adjusted based on a new location of the wearable 312. In some aspects, the wearable may include a supercapacitor or a primary battery such as a coin cell battery. In some aspects, loss of power transmission may initiate a power-saving mode by the wearable 312. In some aspects, the imaging device 302 may sweep the entire space and a signal may be sent by the wearable 312 to the power transmitter 310, initiating power transmission to the wearable device. Thus, even if the patch is occluded such as by clothing, a signal by the wearable 312 may allow the wearable to be identified by the imaging device 302.

The location of the wearable 312 and the positioning of the antenna 306 and the power transmitter 310 may be accomplished in a variety of ways. In some aspects, the wearable may emit an identification signal. Such an identification signal may be audible, such as a “chirp” or “beep,” visual, or an RF signal. In some aspects, the chirp may be ultrasonic. The signal sent by the wearable may allow the system to focus on the general or specific location of the wearable. In some aspects, the signal allows the system to identify that the wearable is in the room or that a wearable is attached to a patient including a specific patient.

In other or combined aspects, an imaging device 302 may pan across an environment to locate objects within the environment such as a patient and/or a wearable. In some aspects, the identification may take place in stages, that is a patient is identified, the imaging device is re-positioned, and then an object associated with the patient is identified. Once the location of the object associated with the patient is identified, the imaging device is re-positioned again such that the wearable is in the center of the field of view of the imaging device. In some aspects, once the image identifies the region of the wearable, the wearable may be triggered to send an identification signal confirming its location, or the location of the wearable may be determined by analyzing the acquired image(s). In some aspects, the signal of the wearable may include a directional component that can be detected by the patient management system 116. In some aspects, once the object such as the wearable 312 is identified and located, the patient management system 116 may send instructions to one or more of the antenna 306, power transmitter 310, gimbal 352, or stand 326, to change position to center the field of view of at least one of the antenna 306, power transmitter 310, and imaging device 302 on the object of interest such as a wearable 312. In some aspects, the information regarding the location of the wearable 312 is repeatedly or continuously updated. For example, the imaging device 302 may acquire images at intervals. The images may be analyzed using, for example, object identification component 118 including machine learning module 120. Once the object of interest has been identified, the patient management system may send instructions for the gimbal 352, the stand 326, the antenna 306 and/or the power transmitter 310 to re-orient so that the antenna 306 and/or power transmitter are directed towards the wearable device 312, that is, the wearable 312 is within the center or the field of view of the antenna 306 and/or power transmitter 310.

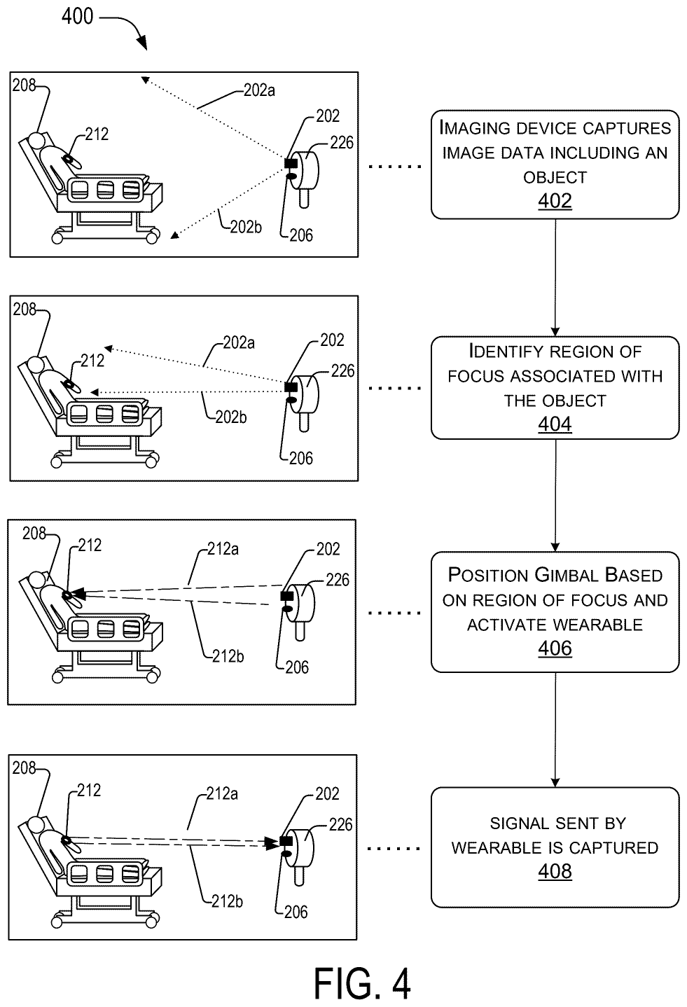

FIG. 4 shows an exemplary schematic block diagram of process 400 capturing a signal from the wearable device. Process 400 may include the patient 208, the imaging device 202, the antenna 206, and the wearable 212 illustrated in FIG. 2.

As shown in FIG. 4, at operation 402, the imaging device 202 may capture image data. The imaging device 202 may be located in a healthcare facility, such as a hospital room, or other care center and may be configured to capture images of the environment in which the imaging device 202 is located. The imaging device 202 may include any device capable of capturing one or more images of an environment in which the imaging device is located. For example, and as illustrated in the current embodiment, the imaging device 202 may be a RGB camera capable of detecting one or more objects in an environment. The imaging device 202 may be located anywhere it is capable of capture the desired image. In some aspects, it may be located independently, for example attached to a wall in the room. In other aspects, it may be mounted on a gimbal 252, or, as shown, on the stand 226 in a room in which the patient 208 is located, and may be configured to capture one or more images of the room. For example, the current embodiment illustrates the imaging device 202 scanning the environment as illustrated by dotted lines 202a and 202b to capture image data. In some examples, the imaging device 202 may send the image data to a patient management system such as patient management system 116 (not shown in this figure) which may input the image data into a machine learning model trained to identify one or more objects in the image data such as machine learning module 120 in object identification component 118. In the current illustration, the machine learning model detects the patient 208 and/or the wearable 212. In some examples, the machine learning model may detect a single object including multiple items (e.g., a patient and an associated device). In other examples, the machine learning model may detect multiple objects that may or may not be associated with one another.

At operation 404, the patient management system may determine a region of focus associated with the object using, for example, region of focus identification component 122. That is, the imaging device 102 may capture a wide view of the area in 402 and then may re-focus, or be re-positioned to focus on the region of interest containing the object of interest as shown by the narrower field of view shown at operation 404. In the current illustration, the patient management system detected the wearable 212 as the region of focus. In some examples, the region of focus may be determined based at least in part on a request from a clinician.

At operation 406, the stand 226 and/or antenna 206 is repositioned such that the wearable 212 is in the center of the field of view of the imaging device 202 and the antenna 206 is directed towards the object of interest. In some aspects, the antenna 206 may be a high-gain directional antenna. The antenna 206 may send a signal as illustrated by dashed lines 212a and 212b to the wearable 212, activating transmission mode. At 408, the wearable 212 then transmits data as illustrated by lines 212a and 212b to the antenna 206 and the signal from the wearable including patient data is captured by the antenna 206.

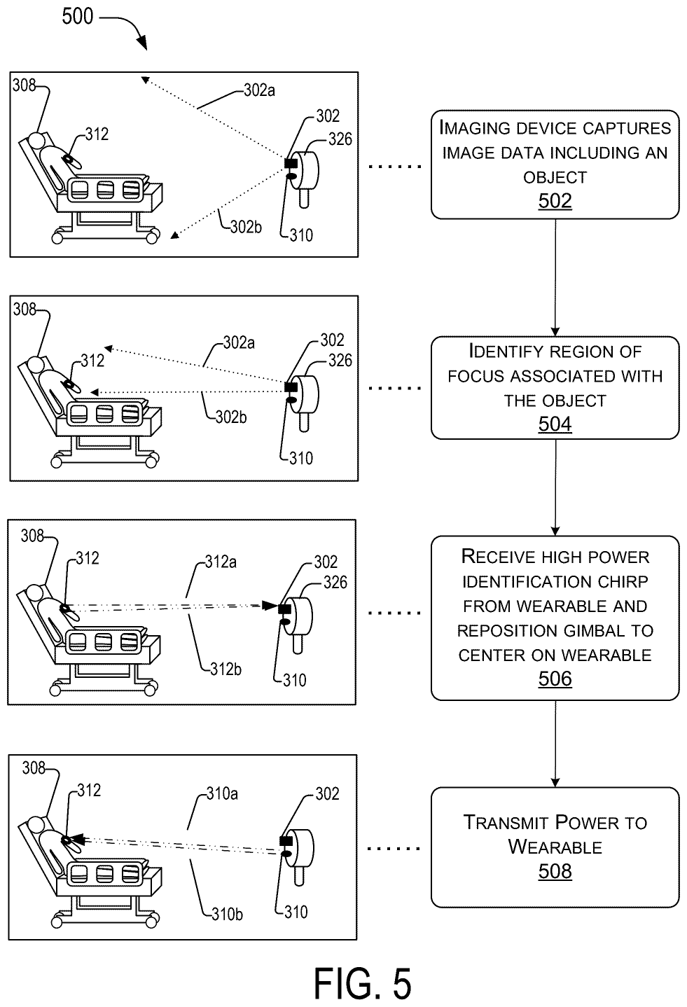

FIG. 5 shows an exemplary schematic block diagram of a process 500 capturing a signal from the wearable device. Process 500 may include the patient 308, the imaging device 302, the power transmitter 310, the stand 326, and the wearable 312 illustrated in FIG. 3.

As shown in FIG. 5, at operation 502, the imaging device 302 may capture image data. For example, the imaging device 302 may be located in a healthcare facility, such as a hospital room, and may be configured to capture images of the environment in which the imaging device 302 is located. For example, and as illustrated in the current embodiment, the imaging device 302 may be a RGB camera capable of detecting one or more objects in an environment. The imaging device 302 may be located anywhere it is capable of capturing the desired image. In some aspects, it may be located independently, for example attached to a wall in the room. In other aspects, it may be mounted on a gimbal 352, or, as shown, on the stand 326 in a room in which the patient 208 is located, and may be configured to capture one or more images of the room.

In the exemplary embodiment shown in FIG. 5, the imaging device 302 scans the environment as illustrated by dotted lines 302a and 302b to capture image data. In some examples, the imaging device 302 may send the image data to a patient management system such as patient management system 116 (not shown here) which may input the image data into a machine learning model trained to identify one or more objects in the image data such as machine learning module 120 in object identification component 118 In the current illustration, the machine learning model detects the patient 308 and/or the wearable 312. In some examples, the machine learning model may detect a single object including multiple items (e.g., a patient and an associated device). In other examples, the machine learning model may detect multiple objects that may or may not be associated with one another.

At operation 504, the patient management system 116 may determine a region of focus associated with the object within the image captured at operation 502 and reposition the imaging device to focus on the object of interest as illustrated by dotted lines 302a and 302b. In the current illustration, the patient management system detected the wearable 312 as the region of focus. In some examples, the region of focus may be determined based at least in part on the request, the patient management system may determine a region of focus associated with the request and/or the image data.

At operation 506, the power transmitter 310 receives a high power identification signal from the wearable 312 as illustrated by dashed lines 312a and 312b, allowing the wearable 312 to be more specifically localized within the region of focus. The power transmitter 310 then sends power to the wearable 312 at 508. In some aspects, the power transmitter 310 may be an RF inductive coil. In some aspects, the RF inductive coil is directional. The power transmitter 310 may send a beam formed RF (AC) energy over the air as illustrated by dashed and double dotted lines 310a and 310b. Thus, milliamps may be transferred from the power transmitter 310 to the wearable 312. Once the wearable 312 starts receiving power, it may move into low power transmission mode, transmitting data to the antenna (not shown in this image).

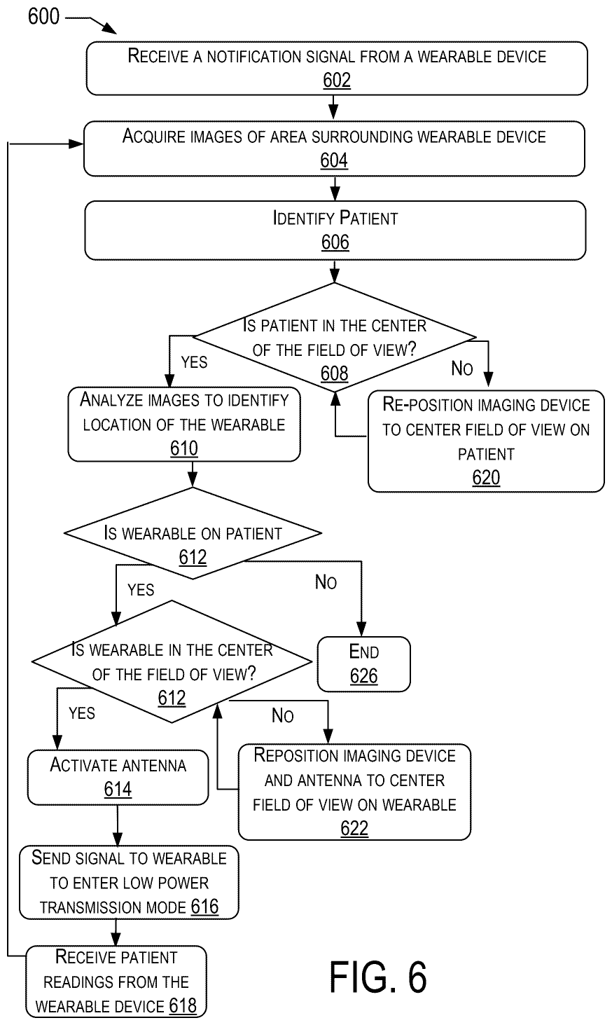

FIG. 6 illustrates a process 600 for locating a wearable such as wearable 112 coupled to a patient. One or more of the devices on a stand receives a notification signal such as an audio chirp or an infrared signal from a wearable device at 602. The notification is transmitted to a system such as patient management system 116. Receipt of the notification signal initiates image acquisition at 604 from an imaging device such as imaging device 102. The images are processed to identify the patient at 606. For example, the patient may be identified using facial recognition software or via a barcode or other label on a wristband or otherwise affixed to the patient, among other identification measures. In some aspects, if the image analysis detects movement in the area around a patient, for example, if there are care providers attending to the patient or other people walking back and forth across the field of view of the imaging device, the imaging device may pause and analyze subsequent images until it is determined that the desired images of the object of interest are being acquired.

Once the patient is identified, the image is analyzed at 608 to determine whether the patient is in the center of the field of view of the imaging device 102. If the patient is not in the center of the field of view at 608, the imaging device is repositioned at 620. Such re-positioning may be independent movement of the imaging device, movement of the gimbal such as gimbal 152, and/or movement of the stand 126. The re-positioning of the imaging device may be done remotely, automatically, and/or mechanically. Once the patient is in the center of the field of view, the images are further analyzed to identify the location of the wearable at 610. If at 612 it is determined that the wearable 112 is not on the patient 108, the process ends at 626. If the wearable is on the patient, the images are analyzed to determine if the wearable 112 is in the center of the field of view at 613. If the wearable 112 is not in the center of the field of view at 613, then the imaging device and/or the antenna is repositioned to center the field of view on the wearable 112 at 622. Once the wearable is in the center of the field of view at 614, the antenna is activated at 616 to send a signal to the wearable 112 to enter low power transmission mode. The antenna then receives patient readings from the wearable device at 618. Image acquisition then repeats either continuously or intermittently to account for changes in the position of the patient, changes in the circumstances of the environment, or changes in the instructions received from the patient management system.

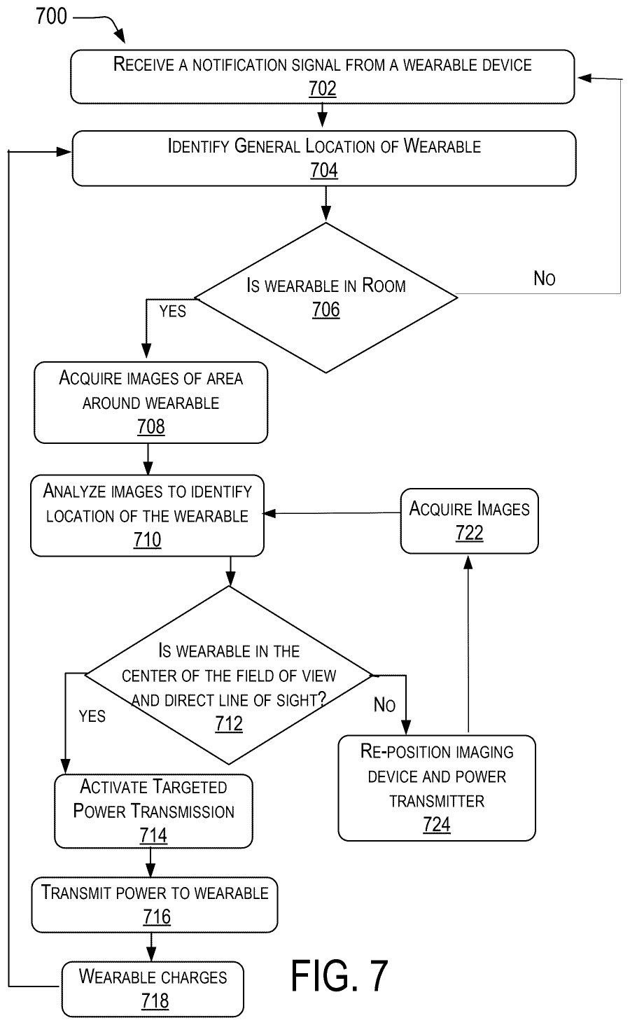

FIG. 7 illustrates a process 700 for charging a wireless device that is not coupled to a patient. A system such as patient management system 116, receives a notification signal from a wearable device at 702. The system hones in on the signal to identify the general location of the wearable at 704. The patient management system 116 identifies whether the wearable is in the room in which a power transmitter such as power transmitter 110 is located at 706. If the wearable is not in the room, the process waits for another notification signal at 702. If the wearable is in the room, images are acquired of the area around the wearable at 708. The images are then analyzed to identify the location of the wearable at 710. The patient management system 116 then determines if the wearable is in the center of the field of view of the imaging device and/or the power transmitter at 712. If it is not in the center of the field of view then the imaging device, the stand, such as stand 126, and/or the gimbal such as gimbal 152 is repositioned to center the wearable in the field of view and positioning the power transmitter so that it is pointed at the wearable at 724, and new images are acquired at 722 and re-analyzed at 710 to determine the position of the wearable. If the wearable is in the center of the field of view and in direct line of sight of the power transmitter, targeted power transmission is activated at 714, power is transmitted to the wearable at 716, and the wearable charges at 718. Charging may be periodic, episodic, or continuous. In some aspects, the notification signal 702 is sent when the wearable needs to be charged. In other aspects, the wearable may be charged continuously. In other aspects, the system may determine when and how much charge should be delivered using, for example, power transmission module 132. The analysis may then be repeated to maintain the charge of the wearable. In some aspects, the system may determine that while the power transmitter is positioned correctly, there is an obstacle between the power transmitter and the wearable. The system may then pause until it is determined that there is a clear line of sight between the power transmitter and the wearable before activating targeted power transmission at 714.

Process 800 charges a wearable on a patient 108. By “on,” the wearable is worn by, in face-sharing contact with, or otherwise directly connected with a surface of the patient, for example, the wearable may be on a patient's wrist in contact with the patient's skin. At 802, the system receives a notification signal from a wearable device. Receipt of the notification signal initiates image acquisition from an imaging device such as imaging device 102 at 804. In some aspects, the imaging device 102 may pan across a room or a portion of the room. In other aspects, the imaging device 102 may acquire images of the area around the source of the notification signal.

The images are then analyzed using for example object identification component 118 to identify the location of the patient in the vicinity of the wearable at 806, that is, the individual most likely to be wearing the wearable. The patient is identified using, for example, object identification component 118, by scanning a bar code, label, or other identification attached to the patient, by facial recognition, and the like. Once the patient is identified, the image is analyzed to determine whether the patient is in the center of the field of view at 808. If the patient is not in the field of view, then the imaging device, a stand such as stand 126, or a gimbal such as gimbal 152 is positioned to center the imaging device on the patient at 826. If the patient is in the center of the field of view of the imaging device 102, then the images are further analyzed to identify the location of the wearable at 810. If the wearable 112 is not in the center of the field of view at 812, then one or more of the imaging device, power transmitter, stand, and/or gimbal is repositioned at 828 to center the field of view on the wearable 112. Once the wearable is in the center of the field of view, the specific location of the wearable on the patient is identified at 814.

The location of the wearable is evaluated for the suitability of charging. For example, some areas of the body may be sensitive to RF transmission or conditions under which power should not be transmitted. Such sensitive areas may include any area biologically, neurologically, physiologically reactive to energy transmission. For example, sensitive areas may be the eyes and testes, or other areas which have difficulty in dissipating excess heat due to a relative lack of blood flow (fcc.gov/engineering-technology/electromagnetic-compatibility-division/radio-frequency-safety/faq/rf-safety #). If the wearable is near a sensitive area susceptible to damage by energy transmission, charging may be delayed at 816 until the wearable is in a different position. In some aspects, a mitigating action may be executed at 830. Such a mitigating action may be waiting a pre-determined amount of time prior to attempting to charge the wearable device, waiting until a sensor indicates that the patient has moved, analyzing images to determine that the wearable is in an appropriate location, or instructing the patient to reposition themselves. Once the wearable is identified as being in a safe position for charging, the gimbal, stand, and/or power transmitter is positioned to limit the beam width to the wearable at 818 as described in further detail in FIGS. 9A and 9B, power transmission is activated at 820, power is sent to the wearable at 822 and the wearable is charged at 824.

FIGS. 9A and 9B illustrate a side view of repositioning of the power transmitter 910, similar to power transmitter 110. As described in further detail with reference to process 800, the stand 926, similar to stand 126; the power transmitter 910, similar to power transmitter 110; and the gimbal 952, similar to gimbal 152 may be manipulated to focus on the patient 908 or the wearable 912, similar to wearable 112. In some aspects, the position of the gimbal 952, the power transmitter 910 and the stand 926 may be adjusted along the x, y, and z axis based on the data acquired from analysis of the images acquired by the imaging device 902. In some aspects, the re-positioning of the power transmitter 110 alters the cone angle of the transmission, that is, the power transmitted is adjusted so that the number of arc seconds or degrees of travel of the transmission is such that there is no overlap beyond the transmitted energy and the receiving area, that is the cone angle is adjusted so that the transmission is about the same size as the receiver, i.e., the wearable.

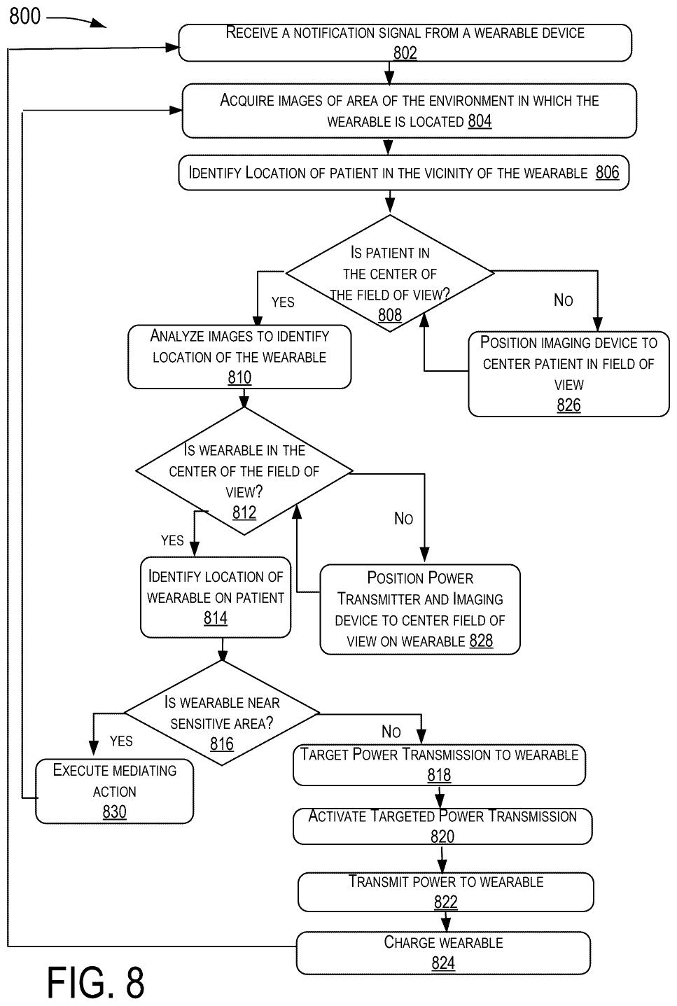

As shown in FIG. 9A, the gimbal 952 is extended along the z-axis such that the power transmitter 910 is closer to the patient 908 than the power transmitter 910 shown in FIG. 9B. The position of the collimator 958 within the power transmitter 910 of FIG. 9A is positioned close to the beam generator so that the cone angle of the power transmitted along dash double dot lines 910a and 910b is narrowly focused on the wearable 912. In FIG. 9B, the gimbal 952 has not been extended, and alternatively, the collimator 958 has been positioned to be further away from the beam generator so that the cone angle of the power transmitted along dash double dot lines 910a and 910b is still narrowly focused on the wearable 912 on the patient 908. In some aspects, once the field of view of the power transmitter 910 has been focused on the wearable 912, new images are acquired to ensure that the power transmitter 910 has a clear line of sight to the wearable. If there is an object such as another person between the wearable 912 and the power transmitter 910 or the wearable 912 is near a sensitive area, charging may be delayed as described in further detail with reference to FIG. 8.

### Example System

FIG. 10 illustrates an example system generally at 1000 that includes a computing device 1002 that is representative of one or more computing systems and/or devices that may implement the various techniques described herein. This is illustrated through the inclusion of the patient management system 116. The computing device 1002 may be, for example, a server of a service provider, a device associated with a client (e.g., a client device), an on-chip system, and/or any other suitable computing device or computing system.

The computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 1006 is illustrated as including memory/storage component 1012. The memory/storage component 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

I/O interface 1008 (Input/Output interface) is representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors. Further, one or more of the various steps described herein may be optional or may be added to one or more of the alternative processes. For example, patient identification as described at 606 may be included in processes 700 or 800 though not explicitly provided therein. Additionally, the process 600 may be combined in whole or in part with the processes 700 or 800. Other various embodiments will be understood by those of ordinary skill in the art.

An implementation of the described modules, techniques, and flowcharts as described herein may be stored on and/or transmitted across some form of computer-readable media. The computer-readable media may include a variety of media that may be accessed by the computing device 1002. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 1002, such as via a network. Computer-readable transmission media typically may transmit computer-readable instructions, data structures, program modules, or other data in a modulated data signal, such as carrier waves, data signals, or other transport mechanisms. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 1010 and computer-readable media 806 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through the use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through the use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also be scalable to provide a corresponding level of scale to encountered demand for the resources 1018 that are implemented via the platform 1016. Accordingly, in an interconnected device embodiment, implementation of functionality described herein may be distributed throughout multiple devices of the system 1000. For example, the functionality may be implemented in part on the computing device 1002 as well as via the platform 1016 which may represent a cloud computing environment.

In some instances, one or more components may be referred to herein as “configured to,” “configurable to,” “operable/operative to,” “adapted/adaptable,” “able to.” “conformable/conformed to,” etc. Those skilled in the art will recognize that such terms (e.g., “configured to”) can generally encompass active-state components and/or inactive-state components and/or standby-state components unless the context requires otherwise.

As used herein, the term “based on” can be used synonymously with “based, at least in part, on” and “based at least partly on.”

As used herein, the terms “comprises/comprising/comprised” and “includes/including/included,” and their equivalents can be used interchangeably. An apparatus, system, or method that “comprises A, B, and C” includes A, B, and C, but also can include other components (e.g., D) as well. That is, the apparatus, system, or method is not limited to components A, B, and C.

### Example Clauses

1. A method including: receiving, by a computing device, image data captured by an imaging device located in a care facility, identifying, by the computing device, a patient represented by the image data; adjusting a position of the imaging device such that a center of a field of view of the imaging device is substantially centered on the patient; identifying, by the computing device and using the image data, a wearable device associated with the patient; adjusting the position of the imaging device such that the center of the field of view of the imaging device is centered on the wearable device; transmitting, via an antenna, a signal to the wearable device, the signal causing the wearable device to: enter a low power transmission mode; and transmit patient data to the computing device; and receiving, by the computing device, the patient data captured by the wearable device, wherein the patient data is captured at a plurality of time points.

2. The method of embodiment 1, wherein the wearable device is on the patient.

3. The method of embodiment 1 or 2, wherein the wearable device captures patient data from the patient wearing the device.

4. The method of any of embodiments 1 to 3, wherein, based on the image data, the position of the antenna is adjusted such that a center of a field of view of the antenna is substantially centered on the wearable device prior to transmitting a signal to the wearable device.

5. The method of embodiment 1, wherein the antenna is a high gain directional antenna.

6. The method of embodiment 5, further including adjusting, via the computing device, a cone angle of the high gain directional antenna, wherein the cone angle is adjusted based on a location of the wearable device relative to the high gain directional antenna.

7. The method of any of embodiments 5 or 6, wherein a signal-to-noise ratio of the high gain directional antenna is 10:1.

8. The method of any of embodiments 6 to 7, wherein the cone angle is less than 10 degrees.

9. The method of any of embodiments 1 to 8, wherein power consumption by the wearable device for data transmission is between 1 milliwatt and 30 milliwatts.

10. The method of any of embodiments 1 to 9, wherein the image data includes a first image data captured at a first time and a second image data captured at a second time, and wherein the position of the imaging device is adjusted between the first time and the second time to center the field of view of the imaging device on the wearable device.

11. The method of any of embodiments 1 to 10, wherein the patient device associated with the wearable device is located on the patient.

12. The method of any of embodiments 1 to 11, wherein the wearable device emits a notification signal, wherein the notification signal is captured by the computing device.

13. The method of embodiment 12, wherein capture of the notification signal initiates image capture by the imaging device.

14 The method of any of embodiments 1 to 13, further including determining an identity of the patient based on the image data, wherein the identity of the patient is obtained via facial recognition or scanning of a label affixed to the patient.

15. A method, including: receiving, by a computing device, image data captured by an imaging device located in a care facility, identifying, by the computing device, a patient; adjusting, by the computing device, a position of the imaging device to center a field of view of the imaging device on the patient; identifying, by the computing device and using the image data, a patient device associated with the patient; adjusting, by the computing device, a position of the imaging device to center the field of view of the imaging device on the patient device; initiating, via the computing device, power transmission from a power transmitter; transmitting power from the power transmitter to the patient device; and charging the patient device via the transmitted power.

16. The method of embodiment 15, further including capturing, via the computing device, a notification signal emitted by the patient device, wherein the notification signal is captured prior to image data capture.

17. The method of embodiment 16, wherein the notification signal is captured by a high gain antenna.

18. The method of any of embodiments 16 to 17, further comprising adjusting, by the computing device, a position of the imaging device based on a location of the transmission of the notification signal.

19. The method of any of embodiments 16 to 18, wherein capture of the notification signal initiates image acquisition by the imaging device.

20. The method of any of embodiments 15 to 19, wherein the field of view of the power transmitter is adjusted such that the patient device is substantially within a center of the field of view of the power transmitter prior to power transmission.

21. The method of embodiment 15, wherein if the patient device is within a threshold distance of a sensitive area, a signal is sent to the patient instructing the patient to change position.

22. A system including: an imaging device located on a gimbal; an antenna located on the gimbal; a sensor located on a patient; one or more processors communicatively coupled to the imaging device, the antenna, and the sensor; and a non-transitory, computer-readable media having instruction stored thereon that, when executed by the one or more processors, cause the one or more processors to perform acts including: receiving image data captured by the imaging device, the image data representing, at least in part, an object; determining, using the image data as an input to a machine learning model, an identification of the object; adjusting, via the gimbal, a position of the imaging device relative to the object, wherein the image data is used to center a field of view of the imaging device on the sensor; and transmitting, via the antenna, a signal to the sensor; wherein receipt of the signal by the sensor causes the sensor to transmit patient data to the one or more processors.

23. The system of embodiment 22, wherein power consumed by the sensor during transmission of the patient data is less than 30 milliwatts.

24. The system of embodiment 22 or 23, wherein the antenna is a high gain directional antenna.

25. The system of embodiment 24, wherein a cone angle of the high gain directional antenna is less than 10 degrees.

26. The system of any of embodiments 22 to 25, further including, adjusting, via the gimbal, a cone angle of the antenna based on a distance between the antenna and the sensor.

The example systems and methods of the present disclosure overcome various deficiencies of known prior art devices. Other embodiments of the present disclosure will be apparent to those skilled in the art from consideration of the specification and practice of the disclosure contained herein. It is intended that the specification and examples be considered as examples only, with a true scope and spirit of the present disclosure being indicated by the following claims.

What is claimed is:

1. A method, comprising:
receiving, by a computing device, image data captured by an imaging device located in a care facility,
identifying, by the computing device, a patient represented by the image data;
adjusting a position of the imaging device such that a center of a field of view of the imaging device is substantially centered on the patient;
identifying, by the computing device and using the image data, a wearable device associated with the patient;
adjusting the position of the imaging device such that the center of the field of view of the imaging device is centered on the wearable device;
transmitting, via an antenna, a signal to the wearable device, the signal causing the wearable device to:
enter a low power transmission mode; and
transmit patient data to the computing device; and
receiving, by the computing device, the patient data captured by the wearable device, wherein the patient data is captured at a plurality of time points.

2. The method of claim 1, wherein the antenna is a high gain directional antenna.

3. The method of claim 2, further comprising adjusting, via the computing device, a cone angle of the high gain directional antenna, wherein the cone angle is adjusted based on a location of the wearable device relative to the high gain directional antenna.

4. The method of claim 2, wherein a signal-to-noise ratio of the high gain directional antenna is 10:1.

5. The method of claim 3, wherein the cone angle is less than 10 degrees.

6. The method of claim 1, wherein power consumption by the wearable device for data transmission is between 1 milliwatt and 30 milliwatts.

7. The method of claim 1, wherein the image data comprises a first image data captured at a first time and a second image data captured at a second time, and wherein the position of the imaging device is adjusted between the first time and the second time to center the field of view of the imaging device on the wearable device.

8. The method of claim 1, wherein the patient device associated with the wearable device is located on the patient.

9. The method of claim 1, wherein the wearable device emits a notification signal, wherein the notification signal is captured by the computing device.

10. The method of claim 9, wherein capture of the notification signal initiates image capture by the imaging device.

11. The method of claim 1, further comprising determining an identity of the patient based on the image data, wherein the identity of the patient is obtained via facial recognition or scanning of a label affixed to the patient.

12. A method, comprising:
receiving, by a computing device, image data captured by an imaging device located in a care facility,
identifying, by the computing device, a patient;
adjusting, by the computing device, a position of the imaging device to center a field of view of the imaging device on the patient;
identifying, by the computing device and using the image data, a patient device associated with the patient;
adjusting, by the computing device, a position of the imaging device to center the field of view of the imaging device on the patient device;
initiating, via the computing device, power transmission from a power transmitter;
transmitting power from the power transmitter to the patient device; and
charging the patient device via the transmitted power.

13. The method of claim 12, further comprising capturing, via the computing device, a notification signal emitted by the patient device, wherein the notification signal is captured prior to image data capture.

14. The method of claim 13, wherein the notification signal is captured by a high gain antenna.

15. The method of claim 12, wherein if the patient device is within a threshold distance of a sensitive area, a signal is sent to the patient instructing the patient to change position.

16. A system comprising:
an imaging device located on a gimbal;
an antenna located on the gimbal;
a sensor located on a patient;
one or more processors communicatively coupled to the imaging device, the antenna, and the sensor; and
a non-transitory, computer-readable media having instruction stored thereon that, when executed by the one or more processors, cause the one or more processors to perform acts comprising:
receiving image data captured by the imaging device, the image data representing, at least in part, an object;
determining, using the image data as an input to a machine learning model, an identification of the object;
adjusting, via the gimbal, a position of the imaging device relative to the object, wherein the image data is used to center a field of view of the imaging device on the sensor; and
transmitting, via the antenna, a signal to the sensor;
wherein receipt of the signal by the sensor causes the sensor to transmit patient data to the one or more processors.

17. The system of claim 16, wherein power consumed by the sensor during transmission of the patient data is less than 30 milliwatts.

18. The system of claim 16, wherein the antenna is a high gain directional antenna.

19. The system of claim 18, wherein a cone angle of the high gain directional antenna is less than 10 degrees.

20. The system of claim 18, further comprising, adjusting, via the gimbal, a cone angle of the antenna based on a distance between the antenna and the sensor.
